(19) United States
(12) Patent Application Publication
(10) Pub. No.: US 2021/0021018 A1
(43) Pub. Date: Jan. 21, 2021

(54) ANTENNA DEVICE AND MOBILE TERMINAL COMPRISING SAME

(71) Applicant: LG ELECTRONICS INC., Seoul (KR)

(72) Inventors: Cheol YOON, Seoul (KR); Younsuk JEONG, Seoul (KR); Wooyoung CHOI, Seoul (KR)

(73) Assignee: LG ELECTRONICS INC., Seoul (KR)

(21) Appl. No.: 17/040,025

(22) PCT Filed: Nov. 12, 2018
(86) PCT No.: PCT/KR2018/013688

§ 371 Date: Sep. 21, 2020

Related U.S. Application Data
(60) Provisional application No. 62/649,544, filed on Mar. 28, 2018.

(51) Int. Cl. H01Q 1/24; H01Q 1/38; H01Q 1/46

(52) U.S. Cl. CPC H01Q 1/243; H01Q 1/46; H01Q 1/38

(57) ABSTRACT

A mobile terminal according to the present invention comprises: a conductive member which forms one side surface of a metal frame of the mobile terminal and which is exposed on the exterior of the terminal; and a plurality of conductive patterns electrically coupled to the conductive member in the metal frame. The plurality of conductive patterns comprises a first conductive pattern and a second conductive pattern which are disposed at both sides with respect to the ground of the conductive member. Here, the first conductive pattern can operate as a radiator of a first antenna and a second antenna, and the second conductive pattern can operate as a radiator of a third antenna and a fourth antenna. The first antenna to the fourth antenna operate as a multi-input multi-output (MIMO) in the same frequency band by a plurality of signals, such that an antenna device having excellent isolation characteristics between a plurality of antenna elements can be provided.

### TECHNICAL FIELD

The present disclosure relates to a mobile terminal including an antenna device for transmitting and receiving a radio signal. More particularly, the present disclosure relates to a mobile terminal having a plurality of antennas.

### BACKGROUND ART

Terminals may be divided into mobile/portable terminals and stationary terminals according to mobility. Mobile terminals may also be classified as handheld terminals or vehicle mounted terminals according to whether or not a user can directly carry the terminal.

Functions of mobile terminals have been diversified. Examples of such functions include data and voice communications, capturing images and video with a camera, recording audio, playing music files with a speaker system, and displaying images and video on a display. Some mobile terminals additionally provide functions such as playing an electronic game, or executing a function of multimedia players. Especially, recent mobile terminals may receive multicast signal for providing visual content such as broadcasts, videos, or television programs.

As it becomes multifunctional, a mobile terminal can be allowed to capture still images or moving images, play music or video files, play games, receive broadcast and the like, so as to be implemented as an integrated multimedia player.

Efforts are ongoing to support and increase the functionality of mobile terminals. Such efforts include software and hardware improvements, as well as changes and improvements in the structural components.

In addition to those attempts, the mobile terminals provide various services by virtue of commercialization of wireless communication systems using various communication technologies. In this regard, attempts have been made to use 5th generation (5G) communication technology in addition to 4th generation (4G) communication technology such as LTE on mobile terminals.

Meanwhile, a mobile terminal using the 5G communication technology needs to provide multi-input multi-output (MIMO) to improve transmission speed or for communication stability. In order to support MIMO in a mobile terminal, a plurality of antennas should be provided, and a space for a separation distance of several wavelengths or more is needed between the plurality of antennas.

Meanwhile, the 5G communication service may be provided in a high frequency band such as a millimeter wave band, but may also be provided in a Sub-6 frequency band of 6 GHz or below. In particular, when the 5G communication service is introduced, it is expected that the communication service is provided using the Sub-6 frequency band of 6 GHz or below. However, it is difficult to secure a separation distance of several wavelengths or more between a plurality of antennas in order to support MIMO in the Sub-6 frequency band.

Therefore, in a case where a separation distance between a plurality of antennas should be within a few wavelengths and, in some cases, within one wavelength to support MIMO in the Sub-6 frequency band, isolation between antennas is very important. However, when a separation distance between a plurality of antennas in the Sub-6 frequency band is close, there is no specific solution for securing isolation between antennas.

### DETAILED DESCRIPTION OF THE DISCLOSURE

### Technical Problem

The present disclosure is directed to solving the aforementioned problems and other drawbacks. Another aspect of the present disclosure is to provide a mobile terminal having a plurality of antenna elements with improved performance.

Another aspect of the present disclosure is to provide an antenna device having excellent isolation characteristics between a plurality of antenna elements in order to support multi-input multi-output (MIMO).

### Technical Solution

To achieve these and other advantages and in accordance with the purpose of this specification, as embodied and broadly described herein, there is provided a mobile terminal including a conductive member which forms one side surface of a metal frame of the mobile terminal and which is exposed on an exterior of the mobile terminal, and a plurality of conductive patterns electrically coupled to the conductive member in the metal frame. Meanwhile, the plurality of conductive patterns may include a first conductive pattern and a second conductive pattern which are disposed at both sides with respect to a ground of the conductive member. Here, the first conductive pattern may operate as a radiator of a first antenna and a second antenna, and the second conductive pattern may operate as a radiator of a third antenna and a fourth antenna. Meanwhile, the first antenna to the fourth antenna operate as a multi-input multi-output (MIMO) in a same frequency band by a plurality of signals, such that an antenna device having excellent isolation characteristics between a plurality of antenna elements can be provided.

According to an embodiment, each of the first antenna to the fourth antenna may include a first conductive line parallel to the conductive member, and a second conductive line bent at a predetermined angle to be connected with the first conductive line, and to which the signals are applied.

According to an embodiment, the mobile terminal may further include a third conductive pattern connected to the ground of the conductive member, and spaced apart from the conductive member by a predetermined interval. Here, the third conductive pattern may include a third conductive line connecting the ground of the conductive member and the conductive member, a fourth conductive line connected to one point of the third conductive line and disposed parallel to the conductive member, and a fifth conductive line connected to the fourth conductive line and an end portion thereof disposed to have a predetermined gap with the conductive member.

According to an embodiment, a first signal may be applied to one end of the second conductive line of the first conductive pattern, and a second signal may be applied to another end of the second conductive line of the first conductive pattern. Further, a third signal may be applied to one end of the second conductive line of the second conductive pattern, and a fourth signal may be applied to another end of the second conductive line of the second conductive pattern. Accordingly, each of the first antenna and the second antenna may be comprised of the first conductive pattern and the conductive member. In addition, each of the third antenna and the fourth antenna may be comprised of the second conductive pattern and the conductive member.

According to an embodiment, the mobile terminal may further include decoupling lines respectively disposed between the second conductive lines of the first conductive pattern and between the second conductive lines of the second conductive pattern. Here, the decoupling line may include a first decoupling line disposed in parallel with the first conductive line to connect between the second conductive lines, and a second decoupling line in which one end thereof is vertically connected to the first decoupling line and another end thereof is connected to the ground.

According to an embodiment, the first conductive line of the first conductive pattern may be in a cut-off form to improve isolation between the first antenna and the second antenna. Further, the first conductive line of the second conductive pattern may be in a cut-off form to improve isolation between the third antenna and the fourth antenna.

According to an embodiment, both ends of the first conductive line of the first conductive pattern may be connected to the ground to improve isolation between the first antenna and the second antenna. In addition, both ends of the first conductive line of the second conductive pattern may be connected to the ground to improve isolation between the third antenna and the fourth antenna.

According to an embodiment, a main region of a radiation pattern of the third antenna may be changed at a predetermined angle by a first cut-off line of the first conductive line, the second conductive line, the third conductive line, and the conductive member to improve an electric coupling coefficient (ECC) between the radiation pattern of the third antenna and a radiation pattern of the fourth antenna.

According to an embodiment, a radiating coupling region of the third antenna may be formed by the first cut-off line and the third conductive line. Accordingly, a radiating coupling region of the fourth antenna may be formed by a second cut-off line of the first conductive line and the conductive member. Here, a decoupling point may be formed between the third antenna and the fourth antenna by the end portion disposed to have the predetermined gap with the conductive member.

According to an embodiment, isolation between the third antenna and the fourth antenna may be improved by allowing a first distance between a first cut-off line of the first conductive line and the conductive member and a second distance between the second cut-off line of the first conductive line and the conductive member to be different from each other.

According to an embodiment, isolation between the third antenna and the fourth antenna may be improved by disposing the fifth conductive line perpendicular to the first cut-off line and the second cut-off line between the first cut-off line and the second cut-off line.

According to an embodiment, a first feeding part configured to feed the first conductive pattern and the second conductive pattern of the third antenna may be disposed on a circuit board of the mobile terminal. Meanwhile, the third conductive pattern of the third antenna and the first conductive pattern and the second conductive pattern of the fourth antenna may be disposed in a rear case of the mobile terminal. Accordingly, isolation between a third signal applied to the second conductive pattern of the third antenna and a fourth signal applied to the second conductive member of the fourth antenna may be improved.

Meanwhile, according to another aspect of the present disclosure, there is provided a mobile terminal, including a conductive member which forms one side surface of a metal frame of the mobile terminal and which is exposed on an exterior of the mobile terminal, and a plurality of conductive patterns electrically coupled to the conductive member in the metal frame. Meanwhile, the plurality of conductive patterns may include a first conductive pattern and a second conductive pattern which are disposed at both sides with respect to a ground of the conductive member. Here, the first conductive pattern may operate as a radiator of a first antenna and a second antenna, and the second conductive pattern may operate as a radiator of a third antenna and a fourth antenna. Meanwhile, an antenna of a first communication system may be implemented by a part of an upper end or a lower end of the metal frame of the mobile terminal, and the first antenna to the fourth antenna may operate as a multi-input multi-output (MIMO) in a same frequency band by a plurality of signals.

According to an embodiment, each of the first antenna to the fourth antenna may include a first conductive line parallel to the conductive member, and a second conductive line bent at a predetermined angle to be connected with the first conductive line, and to which the signals are applied. Here, a first signal may be applied to one end of the second conductive line of the first conductive pattern, and a second signal may be applied to another end of the second conductive line of the first conductive pattern. Further, a third signal may be applied to one end of the second conductive line of the second conductive pattern, and a fourth signal may be applied to another end of the second conductive line of the second conductive pattern. Accordingly, each of the first antenna and the second antenna may be comprised of the first conductive pattern and the conductive member. In addition, each of the third antenna and the fourth antenna may be comprised of the second conductive pattern and the conductive member.

According to an embodiment, the mobile terminal may further include a third conductive pattern connected to the ground of the conductive member, and spaced apart from the conductive member by a predetermined interval. Here, the third conductive pattern may include a third conductive line connecting the ground of the conductive member and the conductive member, a fourth conductive line connected to one point of the third conductive line and disposed parallel to the conductive member, and a fifth conductive line connected to the fourth conductive line and an end portion thereof disposed to have a predetermined gap with the conductive member.

### Advantageous Effects

Hereinafter, effects of a mobile terminal and an antenna device according to the present disclosure will be described.

According to at least one of the embodiments of the present disclosure, a mobile terminal connected to a metal frame and performing multi-input multi-output in a same frequency band by a plurality of conductive patterns disposed therein may be provided.

In addition, according to at least one of the embodiments of the present disclosure, a mobile terminal with improved isolation characteristics between a plurality of antenna elements may be provided by changing some of the plurality of conductive patterns.

Further scope of applicability of the present disclosure will become apparent from the following detailed description. It should be understood, however, that the detailed description and specific examples, such as the preferred embodiment of the disclosure, are given by way of illustration only, since various changes and modifications within the spirit and scope of the disclosure will be apparent to those skilled in the art.

### BRIEF DESCRIPTION OF THE DRAWINGS

FIG. 1A is a block diagram for explaining a mobile terminal related to the present disclosure.

FIGS. 1B and 1C are conceptual views illustrating one example of a mobile terminal according to the present disclosure, viewed from different directions.

FIG. 2 is an exploded perspective view illustrating a mobile terminal in accordance with one embodiment of the present disclosure.

FIGS. 3A and 3B are views illustrating a structure of a mobile terminal having a plurality of antenna elements according to the present disclosure.

FIG. 4A is a conceptual view illustrating a plurality of antenna elements using a metal frame and a conductive pattern inside a mobile terminal according to the present disclosure.

FIG. 4B is a perspective view illustrating a plurality of antenna elements using a metal frame and a conductive pattern inside a mobile terminal according to the present disclosure.

FIGS. 5A and 5B are conceptual views of a current distribution according to signal inputted from different ports and antenna operation principles in a coupled multi-port antenna (CMA) structure according to the present disclosure.

FIGS. 6A and 6B illustrate an antenna structure in which a conductive pattern parallel to a conductive member according to the present disclosure is in a cut-off form.

FIG. 7 illustrates an antenna structure configured in a form in which conductive lines are decoupled from each other.

FIGS. 8A and 8B illustrate a structure in which a cut-off line is connected to a ground to improve isolation in the antenna structure of FIGS. 6A and 6B.

FIGS. 9A and 9B illustrate an equivalent circuit of a decoupling line for improving isolation between antenna ports according to the present disclosure, and an equivalent circuit including both an antenna configuration and a decoupling line.

FIGS. 10A to 10C illustrate various embodiments for improving isolation in the antenna structure according to the present disclosure.

FIG. 11 illustrates an asymmetric conductive pattern according to another embodiment of the present disclosure.

FIGS. 12A and 12B illustrate radiation patterns changed according to asymmetric conductive patterns of a plurality of antennas according to the present disclosure.

### MODES FOR CARRYING OUT PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

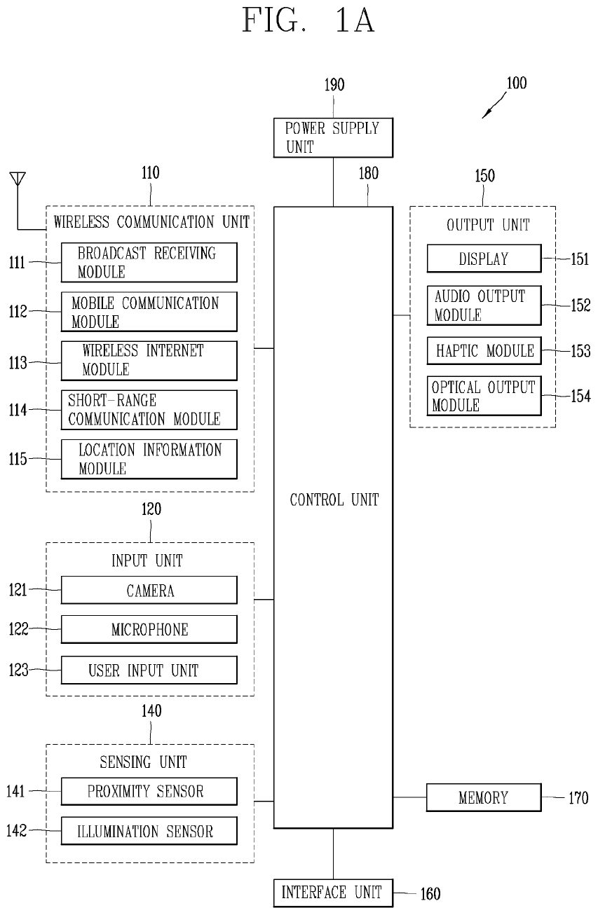

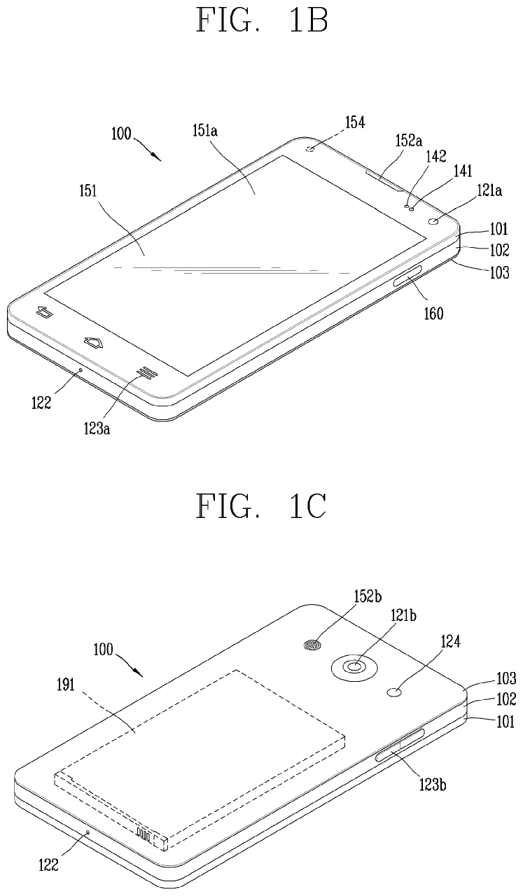

Referring to FIGS. 1A to 1C, FIG. 1A is a block diagram of a mobile terminal in accordance with the present disclosure, and FIGS. 1B and 1C are conceptual views illustrating one example of a mobile terminal, viewed from different directions.

The mobile terminal 100 may be shown having components such as a wireless communication unit 110, an input unit 120, a sensing unit 140, an output unit 150, an interface unit 160, a memory 170, a controller 180, and a power supply 190. It is understood that implementing all of the components illustrated in FIG. 1A is not a requirement, and that greater or fewer components may alternatively be implemented.

In more detail, the wireless communication unit 110 may typically include one or more modules which permit communications such as wireless communications between the mobile terminal 100 and a wireless communication system, communications between the mobile terminal 100 and another mobile terminal, or communications between the mobile terminal 100 and an external server. Further, the wireless communication unit 110 may typically include one or more modules which connect the mobile terminal 100 to one or more networks.

The wireless communication unit 110 may include one or more of a broadcast receiver 111, a mobile communication module 112, a wireless Internet module 113, a short-range communication module 114, and a location information module 115.

The input unit 120 may include a camera 121 or an image input unit for obtaining images or video, a microphone 122, which is one type of audio input device for inputting an audio signal, and the user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the mobile terminal, the surrounding environment of the mobile terminal, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, a red, green, and blue (RGB) sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The mobile terminal disclosed herein may be configured to utilize information obtained from two or more sensors, and combinations thereof.

The output unit 150 may typically be configured to output various types of information, such as audio, video, tactile output, and the like. The output unit 150 may include at least one of a display 151, an audio output module 152, a haptic module 153, and an optical output module 154. The display 151 may have an inter-layered structure or an integrated structure with a touch sensor in order to implement a touch screen. The touch screen may function as the user input unit 123 which provides an input interface between the mobile terminal 100 and the user and simultaneously provide an output interface between the mobile terminal 100 and a user.

The interface unit 160 serves as an interface with various types of external devices that are coupled to the mobile terminal 100. The interface unit 160, for example, may include any of wired or wireless headset ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is implemented to store data to support various functions or features of the mobile terminal 100. For instance, the memory 170 may be configured to store application programs or applications executed in the mobile terminal 100, data or instructions for operations of the mobile terminal 100, and the like. At least one of these application programs may be downloaded from an external server via wireless communication. Other application programs may be installed within the mobile terminal 100 at time of manufacturing or shipping, which is the case for basic functions of the mobile terminal 100 (for example, receiving a call, placing a call, receiving a message, sending a message, and the like). Application programs may be stored in the memory 170, installed in the mobile terminal 100, and executed by the controller 180 to perform an operation (or function) for the mobile terminal 100.

The controller 180 functions to control an overall operation of the mobile terminal 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 may control at least some of the components illustrated in FIG. 1A, to execute an application program that have been stored in the memory 170. In addition, the controller 180 may control at least two of those components included in the mobile terminal 100 to activate the application program.

The power supply unit 190 may be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least part of the components may cooperatively operate to implement an operation, a control or a control method of a mobile terminal according to various embodiments disclosed herein. Also, the operation, the control or the control method of the mobile terminal may be implemented on the mobile terminal by an activation of at least one application program stored in the memory 170.

Referring to FIGS. 1B and 1C, the disclosed mobile terminal 100 includes a bar-like terminal body. However, the mobile terminal 100 may alternatively be implemented in any of a variety of different configurations. Examples of such configurations include watch type, clip-type, glass-type, or a folder-type, flip-type, slide-type, swing-type, and swivel-type in which two and more bodies are combined with each other in a relatively movable manner, and combinations thereof. Discussion herein will often relate to a particular type of mobile terminal. However, such teachings with regard to a particular type of mobile terminal will generally apply to other types of mobile terminals as well.

Here, considering the mobile terminal 100 as at least one assembly, the terminal body may be understood as a conception referring to the assembly.

The mobile terminal 100 will generally include a case (for example, frame, housing, cover, and the like) that defines an appearance of the terminal. In this embodiment, the case may include a front case 101 and a rear case 102. Various electronic components are disposed in a space that is formed by coupling the front case 101 and the rear case 102. At least one middle case may be additionally positioned between the front case 101 and the rear case 102.

The display 151 is located on a front side of the terminal body to output information. As illustrated, a window 151a of the display 151 may be mounted in the front case 101 to form a front surface of the terminal body together with the front case 101.

In some embodiments, electronic components may also be mounted in the rear case 102. Examples of such electronic components include a detachable battery, an identification module, a memory card, and the like. In this case, a rear cover 103 is shown covering the electronic components, and this cover may be detachably coupled to the rear case 102. Therefore, when the rear cover 103 is detached from the rear case 102, the electronic components mounted in the rear case 102 are exposed to the outside.

As illustrated, when the rear cover 103 is coupled to the rear case 102, a side surface of the rear case 102 may partially be exposed. In some cases, upon the coupling, the rear case 102 may also be completely shielded by the rear cover 103. Meanwhile, the rear cover 103 may include an opening for externally exposing a camera 121b or an audio output module 152b.

The cases 101, 102, and 103 may be formed by injection-molding synthetic resin or may be formed of a metal, for example, stainless steel (STS), aluminum (Al), titanium (Ti), or the like.

As an alternative to the example in which the plurality of cases forms an inner space for accommodating components, the mobile terminal 100 may be configured such that one case forms the inner space. In this case, a mobile terminal 100 having a uni-body is formed in such a manner that synthetic resin or metal extends from a side surface to a rear surface.

Meanwhile, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include a display 151, first and second audio output module 152a and 152b, a proximity sensor 141, an illumination sensor 142, an optical output module 154, first and second cameras 121a and 121b, first and second manipulation units 123a and 123b, a microphone 122, an interface unit 160, and the like.

Hereinafter, as illustrated in FIGS. 1B and 1C, description will be given of the exemplary mobile terminal 100 in which the front surface of the terminal body is shown having the display unit 151, the first audio output module 152a, the proximity sensor 141, the illumination sensor 142, the optical output module 154, the first camera 121a, and the first manipulation unit 123a, the side surface of the terminal body is shown having the second manipulation unit 123b, the microphone 122, and the interface unit 160, and the rear surface of the terminal body is shown having the second audio output module 152b and the second camera 121b.

However, those components may not be limited to the arrangement. Some components may be omitted or rearranged or located on different surfaces. For example, the first manipulation unit 123a may not be located on the front surface of the terminal body, and the second audio output module 152b may be located on the side surface of the terminal body other than the rear surface of the terminal body.

The display 151 is generally configured to output information processed in the mobile terminal 100. For example, the display 151 may display execution screen information of an application program executing at the mobile terminal 100 or user interface (UI) and graphic user interface (GUI) information in response to the execution screen information.

The display 151 may include at least one of a liquid crystal display (LCD), a thin film transistor-LCD (TFT LCD), an organic light-emitting diode (OLED), a flexible display, a three-dimensional (3D) display and an e-ink display.

The display 151 may be implemented using two display devices, according to the configuration type thereof. For instance, a plurality of the displays 151 may be arranged on one side, either spaced apart from each other, or these devices may be integrated, or these devices may be arranged on different surfaces.

The display 151 may include a touch sensor that senses a touch with respect to the display 151 so as to receive a control command in a touch manner. Accordingly, when a touch is applied to the display 151, the touch sensor may sense the touch, and a controller 180 may generate a control command corresponding to the touch. Contents input in the touch manner may be characters, numbers, instructions in various modes, or a menu item that can be specified.

On the other hand, the touch sensor may be configured in a form of a film having a touch pattern and disposed between a window 151a and a display (not illustrated) on a rear surface of the window, or may be a metal wire directly patterned on the rear surface of the window. Alternatively, the touch sensor may be formed integrally with the display. For example, the touch sensor may be disposed on a substrate of the display, or may be provided inside the display.

In this way, the display 151 may form a touch screen together with the touch sensor, and in this case, the touch screen may function as the user input unit (123, see FIG. 1A). In some cases, the touch screen may replace at least some of functions of a first manipulation unit 123a.

The first audio output module 152a may be implemented as a receiver for transmitting a call sound to a user's ear and the second audio output module 152b may be implemented as a loud speaker for outputting various alarm sounds or multimedia playback sounds.

The window 151a of the display unit 151 may include sound holes for emitting sounds generated from the first audio output module 152a. However, the present disclosure is not limited thereto, and the sounds may be released along an assembly gap between the structural bodies (for example, a gap between the window 151a and the front case 101). In this case, a hole independently formed to output audio sounds may not be seen or may otherwise be hidden in terms of appearance, thereby further simplifying the appearance of the mobile terminal 100.

The optical output module 154 may be configured to output light for indicating an event generation. Examples of such events may include a message reception, a call signal reception, a missed call, an alarm, a schedule alarm, an email reception, information reception through an application, and the like. When a user has checked a generated event, the controller 180 may control the optical output module 154 to stop the light output.

The first camera 121a may process image frames such as still or moving images obtained by the image sensor in a capture mode or a video call mode. The processed image frames can then be displayed on the display 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion. The first and second manipulation units 123a and 123b may employ any method when it is a tactile manner allowing the user to perform manipulation with a tactile feeling such as touch, push, scroll or the like. The first and second manipulation units 123a and 123b may also be manipulated through a proximity touch, a hovering touch, and the like, without a user's tactile feeling.

The drawings are illustrated on the basis that the first manipulation unit 123a is a touch key, but the present disclosure may not be necessarily limited to this. For example, the first manipulation unit 123a may be configured as a mechanical key, or a combination of a touch key and a push key.

The content received by the first and second manipulation units 123a and 123b may be set in various ways. For example, the first manipulation unit 123a may be used by the user to input a command such as menu, home key, cancel, search, or the like, and the second manipulation unit 123b may be used by the user to input a command, such as controlling a volume level being output from the first or second audio output module 152a or 152b, switching into a touch recognition mode of the display unit 151, or the like.

On the other hand, as another example of the user input unit 123, the rear input unit (not shown) may be disposed on the rear surface of the terminal body. The rear input unit may be manipulated by a user to input a command for controlling an operation of the mobile terminal 100. The content input may be set in various ways. For example, the rear input unit may be used by the user to input a command, such as power on/off, start, end, scroll or the like, controlling a volume level being output from the first or second audio output module 152a or 152b, switching into a touch recognition mode of the display 151, or the like. The rear input unit may be implemented into a form allowing a touch input, a push input or a combination thereof.

The rear input unit may be disposed to overlap the display 151 of the front surface in a thickness direction of the terminal body. As one example, the rear input unit may be disposed on an upper end portion of the rear surface of the terminal body such that a user can easily manipulate it using a forefinger when the user grabs the terminal body with one hand. However, the present disclosure may not be limited to this, and the position of the rear input unit may be changeable.

When the rear input unit is disposed on the rear surface of the terminal body, a new user interface may be implemented using the rear input unit. Also, the aforementioned touch screen or the rear input unit may substitute for at least part of functions of the first manipulation unit 123a located on the front surface of the terminal body. Accordingly, when the first manipulation unit 123a is not disposed on the front surface of the terminal body, the display unit 151 may be implemented to have a larger screen.

On the other hand, the mobile terminal 100 may include a finger scan sensor which scans a user's fingerprint. The controller 180 may use fingerprint information sensed by the finger scan sensor as an authentication means. The finger scan sensor may be installed in the display 151 or the user input unit 123.

The microphone 122 may be configured to receive the user's voice, other sounds, and the like. The microphone 122 may be provided at a plurality of places, and configured to receive stereo sounds.

The interface unit 160 may serve as a path allowing the mobile terminal 100 to interface with external devices. For example, the interface unit 160 may be at least one of a connection terminal for connecting to another device (for example, an earphone, an external speaker, or the like), a port for near field communication (for example, an Infrared DaAssociation (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b may be further mounted to the rear surface of the terminal body. The second camera 121b may have an image capturing direction, which is substantially opposite to the direction of the first camera unit 121a.

The second camera 121b may include a plurality of lenses arranged along at least one line. The plurality of lenses may be arranged in a matrix form. The cameras may be referred to as an ‘array camera.’ When the second camera 121b is implemented as the array camera, images may be captured in various manners using the plurality of lenses and images with better qualities may be obtained.

The flash 124 may be disposed adjacent to the second camera 121b. When an image of a subject is captured with the second camera 121b, the flash 124 may illuminate the subject.

The second audio output module 152b may further be disposed on the terminal body. The second audio output module 152b may implement stereophonic sound functions in conjunction with the first audio output module 152a, and may be also used for implementing a speaker phone mode for call communication.

At least one antenna for wireless communication may be disposed on the terminal body. The antenna may be embedded in the terminal body or formed in the case. For example, an antenna which configures a part of the broadcast receiving module 111 (see FIG. 1A) may be retractable into the terminal body. Alternatively, an antenna may be formed in a form of film to be attached onto an inner surface of the rear cover 103 or a case including a conductive material may serve as an antenna.

The terminal body is provided with a power supply unit 190 (see FIG. 1A) for supplying power to the mobile terminal 100. The power supply unit 190 may include a batter 191 which is mounted in the terminal body or detachably coupled to an outside of the terminal body.

The battery 191 may receive power via a power cable connected to the interface unit 160. Also, the battery 191 may be (re)chargeable in a wireless manner using a wireless charger. The wireless charging may be implemented by magnetic induction or electromagnetic resonance.

On the other hand, the drawing illustrates that the rear cover 103 is coupled to the rear case 102 for shielding the battery 191, so as to prevent separation of the battery 191 and protect the battery 191 from an external impact or foreign materials. When the battery 191 is detachable from the terminal body, the rear case 103 may be detachably coupled to the rear case 102.

An accessory for protecting an appearance or assisting or extending the functions of the mobile terminal 100 may further be provided on the mobile terminal 100. As one example of the accessory, a cover or pouch for covering or accommodating at least one surface of the mobile terminal 100 may be provided. The cover or pouch may cooperate with the display 151 to extend the function of the mobile terminal 100. Another example of the accessory may be a touch pen for assisting or extending a touch input onto a touch screen.

Hereinafter, embodiments related to an antenna device having such configuration and a mobile terminal having the antenna device will be described with reference to the accompanying drawings. It will be apparent to those skilled in the art that the present disclosure may be embodied in other specific forms without departing from the spirit or essential characteristics thereof.

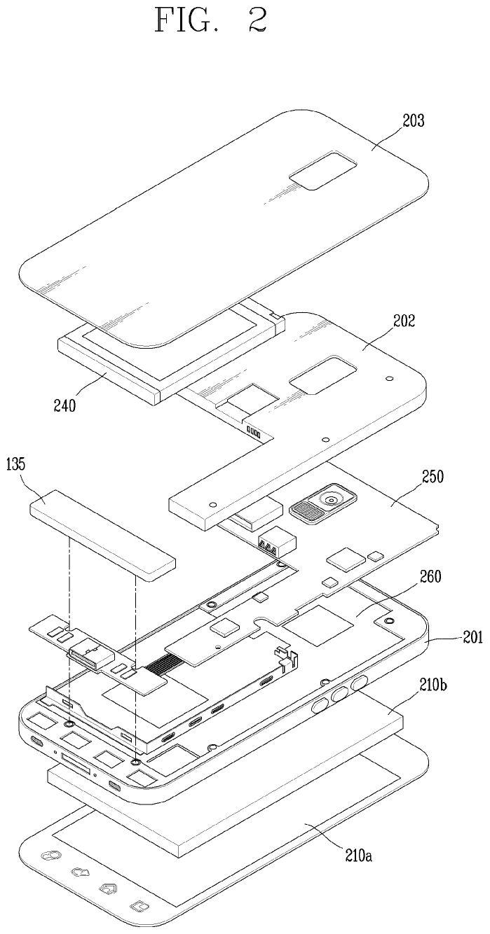

First, FIG. 2 is an exploded perspective view of a mobile terminal according to one embodiment of the present disclosure. Referring to FIG. 2, the mobile terminal includes a window 210a and a display module 210b, which constitute the display unit 210. The window 210a may be coupled to one surface of a front case 201. The window 210a and the display module 210b may be integrally formed with each other.

A frame 260 is formed between the front case 201 and a rear case 202 to support electric elements. In this regard, when the front case 201 and the rear case 202 are made of a metal, they may be referred to as a metal frame. In the present disclosure, the front case 201 is referred to as a metal frame 201 for the sake of explanation, but is not limited thereto. Alternatively, at least one of the front case 201 and the rear case 202 may be implemented as a metal frame made of a metal material. Meanwhile, at least a part of the side surface of the metal frame 201 may operate as an antenna.

The frame 260 is a support structure inside the terminal. As one example, the frame 260 is configured to support at least one of the display module 210b, a camera module 221, an antenna device, a battery 240 or a circuit board 250.

A part of the frame 260 may be exposed to the outside of the terminal. Also, the frame 260 may constitute a part of a sliding module that connects the main body and the display unit to each other in a slide type terminal, which is not a bar type.

FIG. 2 illustrates one example in which the circuit board 250 is disposed between the frame 260 and the rear case 202 and the display module 210b is coupled to one surface of the frame 260. The circuit board 250 and the battery may be disposed on another surface of the frame 260 and a battery cover 203 may be coupled to the rear case 202 to cover the battery.

The window 210a is coupled to one surface of the front case 201. A touch detecting pattern 210c for detecting a touch may be formed on one surface of the window 210a. The touch detecting pattern 210c is configured to detect a touch input, and is made to be light-transmissive. The touch detecting pattern 210c may be mounted on a front surface of the window 210a and may be configured to convert a change in voltage or the like generated in a specific portion of the window 210a into an electrical input signal.

The display module 210b is mounted on a rear surface of the window 210a. This embodiment exemplarily illustrates that the display module 210b is a thin film transistor-liquid crystal display (TFT LCD), but the present disclosure is not limited thereto.

For example, the display module 210b may be a liquid crystal display (LCD), an organic light-emitting diode (OLED), a flexible display, a three-dimensional display, and the like.

As described above, the circuit board 250 may be provided on one surface of the frame 260, but may alternatively be mounted on a lower portion of the display module 210b. And, at least one electronic element is mounted on a lower surface of the circuit board 250.

The frame 260 is provided with an accommodating portion in a recessed shape so that the battery 240 is accommodated therein. On one side surface of the battery accommodating portion, a contact terminal connected to the circuit board 250 may be provided so that the battery 240 supplies power to the terminal body.

The frame 260 may be made of a metal material to maintain sufficient rigidity even if the frame 260 is formed to have a small thickness. The frame 260 made of a metal material may operate as a ground. That is, the circuit board 250 or the antenna device may be grounded to the frame 260, and the frame 260 may operate as a ground of the circuit board 250 or a ground of the antenna device. In this case, the frame 260 may extend the ground of the mobile terminal.

The circuit board 250 is electrically connected to the antenna device and is configured to process radio signals (or radio electromagnetic waves) transmitted and received through the antenna device. For the processing of the radio signals, a plurality of transceiver circuits may be formed or mounted on the circuit board 250.

The transceiver circuits may include one or more integrated circuits and associated electrical components. In one example, the transceiver circuits may include a transmission integrated circuit, a reception integrated circuit, a switching circuit, an amplifier, and the like.

The plurality of transceiver circuits may simultaneously feed conductive members configured by conductive patterns, which are radiators, so that a plurality of antenna devices operates simultaneously. For example, while one antenna performs transmission, another one may perform reception, or both of them may perform transmission or reception.

A coaxial cable may be configured to connect the circuit board and each of the antenna devices. In one example, the coaxial cable may be connected to feeders that feed the antenna devices. The feeders may be provided on one surface of a flexible circuit board 242 which processes signals inputted from the manipulation unit 123a. Another surface of the flexible circuit board 242 may be coupled to a signal transfer unit that is configured to transmit a signal of the manipulation unit 123a. In this case, a dome may be formed on the another surface of the flexible circuit board 242, and an actuator may be provided on the signal transfer unit.

The flexible circuit board 242 is connected to a lower portion of a carrier 135. One end of the flexible circuit board 242 may be connected to the circuit board 250 provided with a controller. The flexible circuit board 242 may be connected to the manipulation unit 123a of the terminal. In this case, the flexible circuit board 242 is configured such that a signal generated by the manipulation unit 123a is transmitted to the controller of the circuit board 250.

Hereinafter, a mobile terminal in which at least part of a side surface of the metal frame 201 operates as an antenna in accordance with the present disclosure will be described. In this regard, at least a part of the side surface of the metal frame 201 may operate as a plurality of antenna elements.

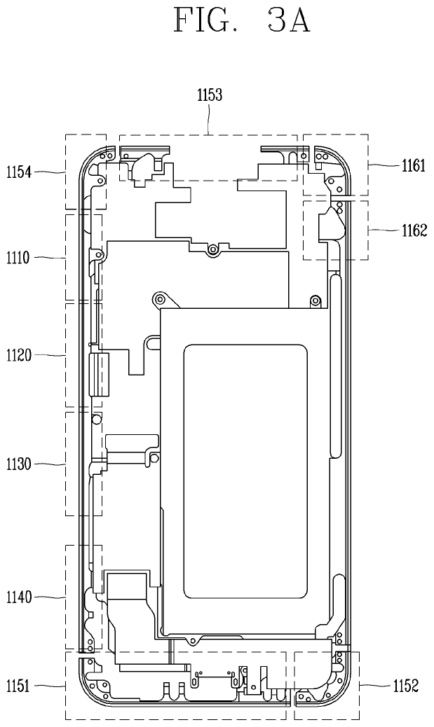

Meanwhile, FIGS. 3A and 3B are views illustrating a structure of a mobile terminal having a plurality of antenna elements according to the present disclosure. Referring to FIG. 3A, a plurality of antenna elements 1110 to 1140 supporting the 5G communication service may be disposed on one side surface, e.g., on a left side surface of a metal frame of a mobile terminal. Meanwhile, the number of the antenna elements 1110 to 1140 is not limited to four, and can be variously changed according to applications.

Meanwhile, the present disclosure aims to apply 4 or 8 antennas to a limited size of a mobile terminal due to characteristics of the 5G Sub-6 GHz. To this end, the Sub-6 GHz antenna region except the 4G antenna region (upper end, lower end) is limited to a side surface portion. Also, a method for sharing some of the 5G antennas with the 4G antenna may be considered.

In this regard, a mobile terminal needs to support not only the 5G communication service, but also the existing 4G communication service, WiFi communication service, GPS service, and others. In relation to the LTE communication service, which is the 4G communication service, a mobile terminal should operate in a low-band (LB), a middle-band (MB), and a high-band (HB). In this regard, a plurality of antenna elements 1151 to 1154 supporting the 4G communication service may be disposed on one side surface of the mobile terminal, for example, an upper end portion and a lower end portion of the mobile terminal.

In addition, when an additional 5G circuit module (e.g., a millimeter wave (mmWave) module) is added to the antenna, the Sub-6 GHz antenna region may be further limited.

Meanwhile, the plurality of antenna elements 1110 to 1140 supporting the 5G communication service may operate in a same frequency band. On the other hand, the plurality of antenna elements 1151 to 1154 supporting the 4G communication service may operate in different frequency bands. For example, the plurality of antenna elements 1151 to 1154 may operate in different frequency bands corresponding to the aforementioned LB, MB, and HB.

Accordingly, in relation to the plurality of antenna elements 1110 to 1140, a method of using a single antenna pattern on a multi-port to reduce an antenna space may be used. Accordingly, in the present disclosure, an antenna may be designed by using a conductive pattern corresponding to a coupling pattern within the same frequency band (e.g., 3.5 GHz band in Sub-6 GHz band).

An antenna with such a coupling pattern has an advantage in that a size thereof can be reduced compared to a general planar inverted-F antenna (PIFA) type antenna. In addition, as the antenna is configured as a multi-port antenna by using a coupling pattern so as to share some regions of antenna, the size of the antenna can be reduced.

As described above, the antenna having the coupling pattern according to the present disclosure may be implemented in a limited space as illustrated in FIG. 3. Specifically, the size of the antenna may be reduced to about 50%, and accordingly, the antenna may be easily disposed on a side surface portion of the mobile terminal as illustrated in FIGS. 3A and 3B. In addition, there is an advantage in that a degree of freedom to share some of the 4G antennas with the 5G antennas increases.

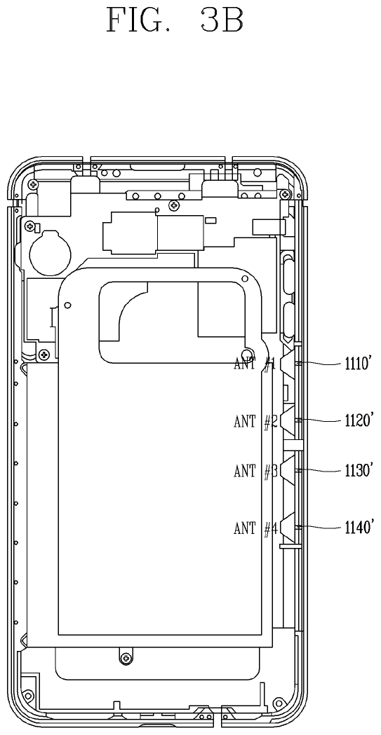

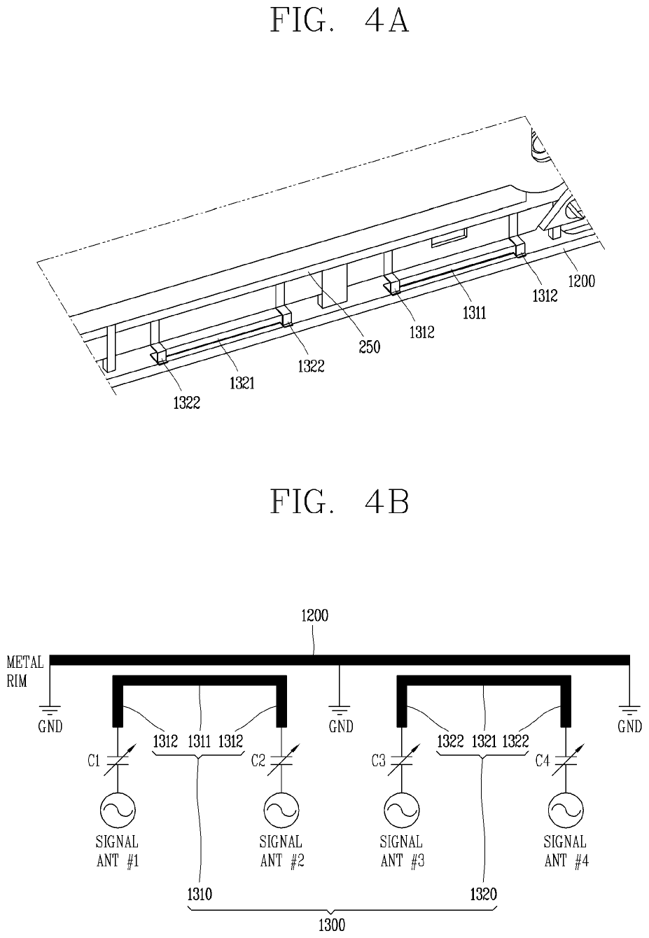

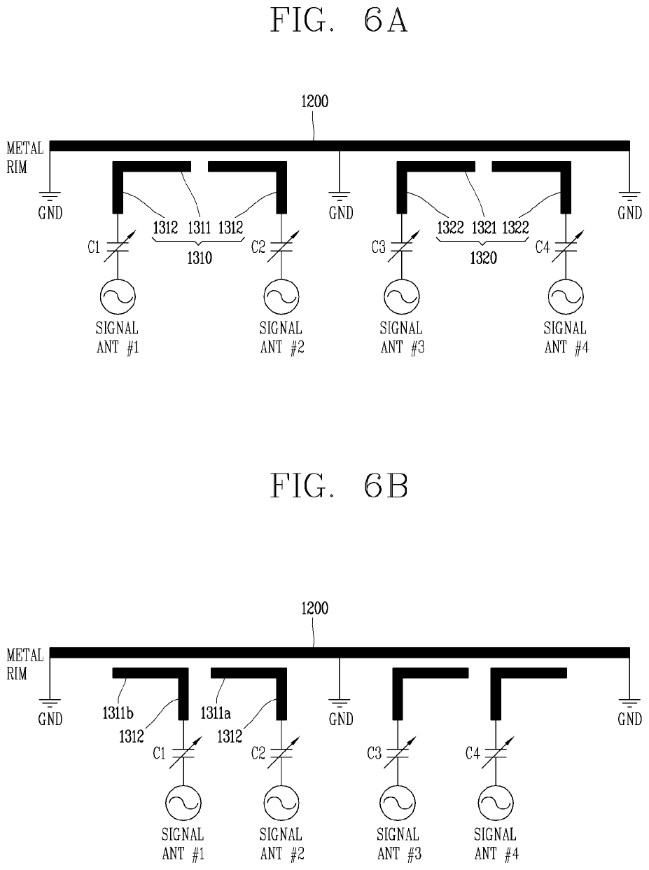

In addition, various antenna topologies, for example, the antenna topologies of FIGS. 6 to 8 and 10 based on the proposed structure of FIGS. 4A and 4B, i.e., a basic structure of an antenna can be implemented. That is, an antenna may be configured as various antennas of a coupling pattern type by separating multiple ports.

As described above, at least one of the plurality of antenna elements 1110 to 1140 supporting the 5G communication service may operate in the 4G frequency band in addition to the 5G frequency band. For example, the antenna element 1140 disposed adjacent to the antenna element 1151 supporting the 4G communication service may operate in the 4G frequency band in addition to the 5G frequency band.

Meanwhile, any one of a plurality of antenna elements 1151 to 1154 supporting the 4G communication service may support a global positioning system (GPS) service. In addition, WiFi antennas 1161 and 1162 may be disposed on another side surface of the metal frame of the mobile terminal.

Meanwhile, referring to FIG. 3B, a plurality of antenna elements 1110′ to 1140′ supporting the 5G communication service may be disposed on another side surface, e.g., on a right side surface of a metal frame of a mobile terminal. In this regard, referring to FIG. 3A, WiFi antennas 1161 and 1162 may be disposed on another side surface of the metal frame. Also, referring to FIG. 2, physical buttons may be disposed on the another side surface of the metal frame. Accordingly, the plurality of antenna elements 1110′ to 1140′ illustrated in FIG. 3B should be disposed in a space narrower than a space in which the plurality of antenna elements 1110 to 1140 illustrated in FIG. 3A are disposed. Accordingly, it can be seen that a method for improving isolation among the plurality of antenna elements 1110′ to 1140′ is more important.

Meanwhile, FIG. 4A is a conceptual view illustrating a plurality of antenna elements using a metal frame and a conductive pattern inside a mobile terminal according to the present disclosure. In addition, FIG. 4B is a perspective view illustrating a plurality of antenna elements using a metal frame and a conductive pattern inside a mobile terminal according to the present disclosure.

Referring to FIGS. 2 and 4A, a plurality of conductive patterns may be disposed on one surface of the rear case 202 and may be electrically coupled to the metal frame 201. Meanwhile, a conductive member 1200 may be configured to form a part of the metal frame 201. Specifically, the conductive member 1200 forms one side surface of the metal frame 201 of the mobile terminal and may be exposed on an exterior of the mobile terminal.

Here, as the conductive member 1200 corresponds to a part of the metal frame 201, it may be referred to as a metal rim. Meanwhile, both ends of the conductive member 1200 may be connected to the ground, and one point near a center of the conductive member 1200 may also be connected to the ground. For example, both ends of the conductive member 1200 and one point near the center of the conductive member 1200 may be connected to the ground of the circuit board 250.

Meanwhile, a plurality of conductive patterns 1300 may include a first conductive pattern 1310 and a second conductive pattern 1320 which are disposed on opposite sides based on the ground of the conductive member. Here, since the plurality of conductive patterns 1300 is disposed parallel to the conductive member 1200, that is a metal frame, to be electrically coupled thereto, it may be referred to as a coupling pattern. Accordingly, the first conductive pattern 1310 and the second conductive pattern 1320 may be referred to as a first coupling pattern 1310 and a second coupling pattern 1320.

Meanwhile, the first conductive pattern 1310 may operate as a radiator of a first antenna ANT1 and a second antenna ANT2, and the second conductive pattern 1320 may operate as a radiator of a third antenna ANT3 and a fourth antenna ANT4.

Meanwhile, the first antenna ANT1 to the fourth antenna ANT4 may operate as a multi-input multi-output (MIMO) in a same frequency band by a plurality of signals. And, there is a technical difference in that a plurality of conductive patterns operates in different frequency bands in the related art mobile terminal, whereas the plurality of antennas by the plurality of conductive patterns 1300 of the present disclosure performs multi-input multi-output (MIMO) in a same frequency band by a plurality of signals applied at different points.

Meanwhile, each of the first conductive pattern 1310 and the second conductive pattern 1320 includes a first conductive line 1311, 1321 and a second conductive line 1312, 1322. In this regard, each of the first antenna ANT1 to the fourth antenna ANT4 includes the first conductive line 1311, 1321 and the second conductive line 1312, 1322. Specifically, the first antenna ANT1 and the second antenna ANT2 include the first conductive line 1311 and the second conductive line 1312. In addition, the third antenna ANT3 and the fourth antenna ANT4 include the first conductive line 1321 and the second conductive line 1322.

Here, each of the first conductive lines 1311, 1321 may correspond to a common connection portion of the first antenna ANT1 and the second antenna ANT2 or to a common connection portion of the third antenna ANT3 and the fourth antenna ANT4, as illustrated.

However, the first conductive line 1311, 1321 that is limited to the common connection portion may be configured as a cut-off structure as described below.

In this regard, the first conductive lines 1311, 1321 are disposed parallel to the conductive member 1200 that is the metal frame. Further, the second conductive lines 1312, 1322 are bent at a predetermined angle to be connected to the first conductive lines 1311, 1321, and configured such that signals from the circuit board 250 are applied thereto.

Meanwhile, a first signal may be applied to one end of the second conductive line 1312 of the first conductive pattern 1310, and a second signal may be applied to another end of the second conductive line 1312 of the first conductive pattern 1310. In addition, a third signal may be applied to one end of the second conductive line 1322 of the second conductive pattern 1320, and a fourth signal may be applied to another end of the second conductive line 1322 of the second conductive pattern 1320. Here, the first to fourth signals may be applied to the second conductive lines 1312, 1322 by direct feeding in which signal lines are directly connected or by indirect feeding in which signal lines are connected by coupling. At this time, in the case of indirect feeding connected by coupling, it can be expressed as being connected to the second conductive lines 1312, 1322 through capacitors C1 to C4 as illustrated in FIG. 4B.

According to the first signal and the second signal described above, the first conductive pattern 1310 and the conductive member 1200 may operate as the first antenna ANT1 and the second antenna ANT2. On the other hand, according to the third signal and the fourth signal, the second conductive pattern 1320 and the conductive member 1200 may operate as the third antenna ANT3 and the fourth antenna ANT4.

On the other hand, since the conductive member 1200 and the plurality of conductive patterns 1310, 1320 are electrically coupled, and there is provided a plurality of antenna ports in the aforementioned first to fourth antennas ANT 1 to ANT4, the antennas may be referred to as a coupled multi-port antenna (CMA).

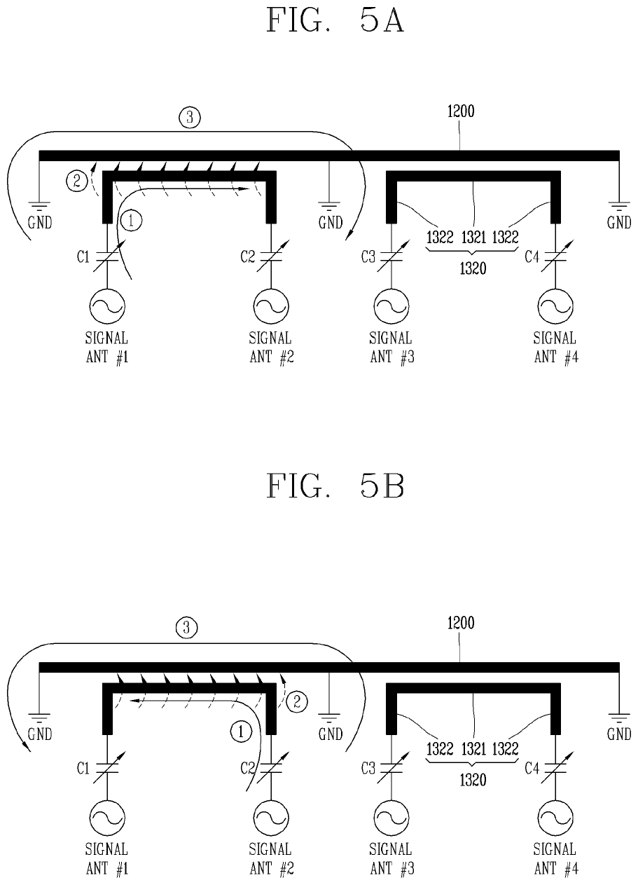

Meanwhile, FIGS. 5A and 5B are conceptual views of a current distribution according to signal inputted from different ports and antenna operation principles in the CMA structure according to the present disclosure.

Referring to FIGS. 4B and 5A, a signal excitation is performed to a port 1 of the first antenna ANT1. Next, an electrical coupling to the conductive member 1200 occurs through the first conductive line 1311 of the first conductive pattern 1310. Due to the electrical coupling, resonance occurs according to an electrical length between a ground at one end of the conductive member 1200 and a ground at one point near the center. Therefore, resonance occurs according to an electrical length, for example, I/4, at an operating frequency, for example, 3.5 GHz, which is one frequency of the Sub-6 frequency band, and operates as an antenna.

In addition, referring to FIGS. 4B and 5B, a signal excitation is performed to a port 2 of the second antenna ANT2. Next, an electrical coupling to the conductive member 1200 occurs through the first conductive line 1311 of the first conductive pattern 1310. Due to the electrical coupling, resonance occurs according to electrical lengths between a ground at one end of the conductive member 1200 and a ground at one point near the center. Therefore, resonance occurs according to an electrical length, for example, I/4, at an operating frequency, for example, 3.5 GHz, which is one frequency of the Sub-6 frequency band, and operates as an antenna.

Likewise, the principle of sequentially performing signal excitation, electrical coupling occurrence, operating according to an electrical length at an operating frequency is applied to a port 3 and a port 4 of the third antenna ANT3 and the fourth antenna ANT4. However, an electrical coupling to the conductive member 1200 occurs through the first conductive line 1321 of the first conductive pattern 1320.

Meanwhile, a conductive pattern parallel to the conductive member among the plurality of conductive patterns may be cut off to improve isolation, or may be configured in a form in which conductive lines are decoupled from each other.

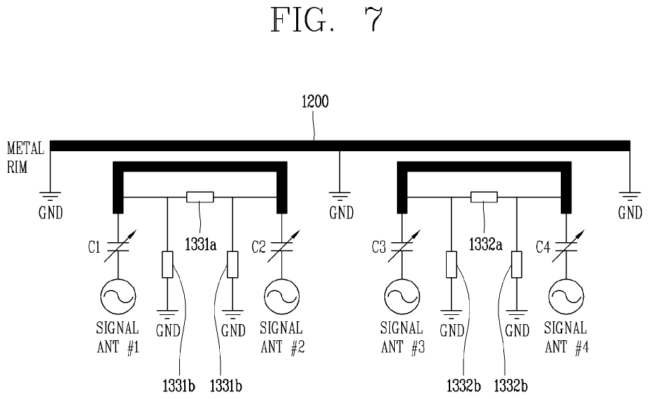

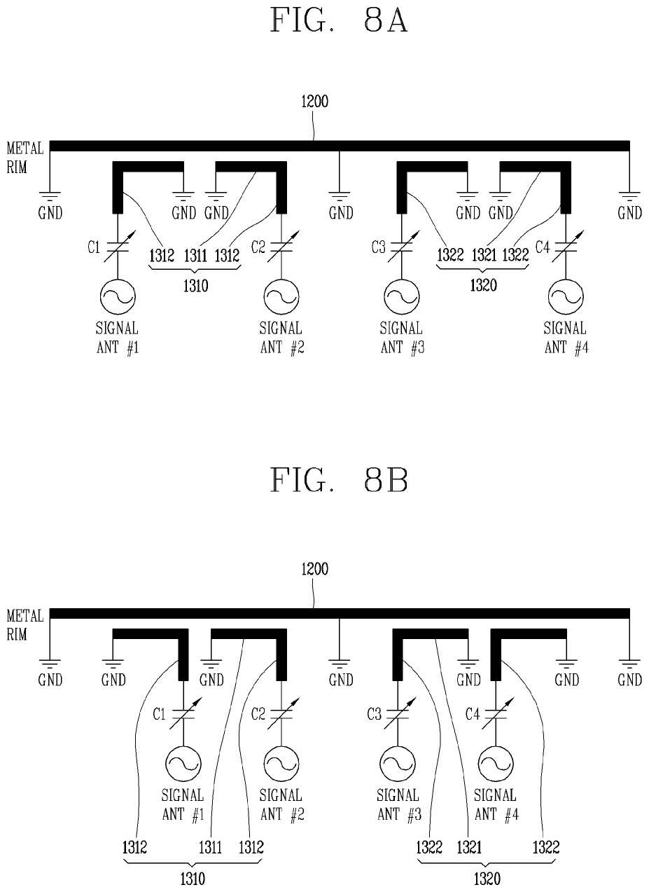

In this regard, FIGS. 6A and 6B illustrate an antenna structure in which a conductive pattern parallel to a conductive member according to the present disclosure is in a cut-off form. Meanwhile, FIG. 7 illustrates an antenna structure configured in a form in which conductive lines are decoupled from each other. Meanwhile, FIGS. 8A and 8B illustrate a structure in which a cut-off line is connected to a ground to improve isolation in the antenna structure of FIGS. 6A and 6B.

Referring to FIGS. 6A and 6B, the first conductive line 1311 of the first conductive pattern 1310 may be in a cut-off form to improve isolation between the first antenna ANT1 and the second antenna ANT2. Also, the first conductive line 1321 of the second conductive pattern 1320 may be in a cut-off form to improve isolation between the third antenna ANT3 and the fourth antenna ANT4.

Meanwhile, according to the port configuration of the first antenna ANT1 and the second antenna ANT2, one of the second conductive lines 1312 may be connected to one of the cut-off first conductive lines 1311 as illustrated in FIG. 6B. In addition, the structure in which one of the second conductive lines 1312 is connected to one of the cut-off first conductive lines 1311 may be more advantageous in a view of isolation, as the second conductive lines 1312 are disposed between the cut-off conductive lines 1311. That is, an electrical coupling from a first cut-off line 1311a, which is one of the first conductive lines, to a second cut-off line 1311b, which is another one of the first conductive lines is reduced, so that isolation between port 1 and port 2 is improved.

Meanwhile, referring to FIGS. 4B and 7, each of decoupling lines 1331, 1332 is disposed between the second conductive lines 1312 of the first conductive pattern 1310 and between the second conductive lines 1332 of the second conductive pattern 1320. Here, the decoupling lines 1331, 1332 may include first decoupling lines 1331a, 1332a and second decoupling lines 1331b, 1332b. The first decoupling lines 1331a, 1332a are disposed parallel to the first conductive lines 1311, 1321 and configured to connect between the second conductive lines 1312 and between the second conductive lines 1322. Meanwhile, one end of each of the second decoupling lines 1331b, 1332b may be vertically connected to each of the first decoupling lines 1331a, 1332a, and another end thereof may be connected to a ground.

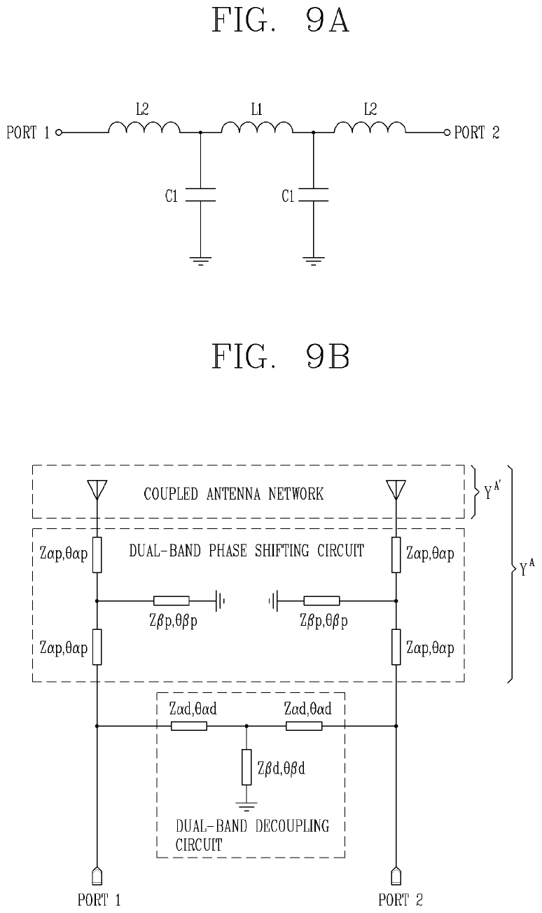

The decoupling lines 1331, 1332 may be referred to as Π matching circuits, as illustrated in FIG. 9. That is, FIGS. 9A and 9B illustrate equivalent circuits of decoupling lines for improving isolation between antenna ports according to the present disclosure, and equivalent circuits including both an antenna configuration and decoupling lines. That is, FIG. 9A illustrates equivalent circuits of decoupling lines for improving isolation between antenna ports according to the present disclosure. On the other hand, FIG. 9B illustrates equivalent circuits including both an antenna configuration and decoupling lines according to the present disclosure.

Meanwhile, each of the decoupling lines 1331, 1332 according to the present disclosure may be configured as a microstrip line in a form of a printed circuit as illustrated in FIG. 7. Further, the decoupling lines 1331, 1332 according to the present disclosure may be configured such that inductors L and capacitors C are connected in series or in parallel as illustrated in FIG. 9A. Meanwhile, even in a case where each of the decoupling lines 1331, 1332 is configured as a microstrip line, it can be expressed as an LC equivalent circuit as illustrated in FIG. 9A.

Meanwhile, referring to FIG. 9B, the entire equivalent circuit configuration may include a coupled multi-port antenna (CMA) network, a dual-band phase shifting circuit, and a dual-band decoupling circuit. In this regard, the first antenna ANT1 and the second antenna ANT2 of FIG. 7 correspond to each of the antennas of the CMA network of FIG. 9B.

Meanwhile, the decoupling lines 1331, 1332 of FIG. 7 correspond to dual-band decoupling circuits of FIG. 9B. Here, the decoupling lines 1331, 1332 of FIG. 7 are Π matching circuits, and the dual-band decoupling circuits of FIG. 9B are T matching circuits, but are not limited thereto and can be variously changed according to applications. Meanwhile, the Π matching circuit and the T matching circuit can be mutually converted.

Meanwhile, when a phase shift between the plurality of antenna elements is not performed, the dual-band phase shifting circuits of FIG. 9B may be connection circuits having a same parameter value. Meanwhile, as illustrated in FIG. 6B, when the first antenna ANT1 and the second antenna ANT2 are asymmetrical, the parameter value may be different from each other.

Meanwhile, with the entire equivalent circuit configuration, it is possible to predict isolation even at different frequencies by using information on isolation between antenna elements measured at one frequency. In addition, with the entire equivalent circuit configuration, the decoupling lines 1331, 1332 may be designed to improve isolation characteristics for all desired frequency bands.

Meanwhile, referring to FIGS. 8A and 8B, cut-off lines may be connected to grounds in the structures of FIGS. 6A and 6B. For example, a cut-off first conductive line 1311 may be connected to a ground of the circuit board 250. As described above, as the cut-off first conductive line 1311 is connected to the ground of the circuit board 250, an electrical coupling between the cut-off first conductive lines 1311 decreases, and thus isolation between antenna ports is improved.

Specifically, in order to improve isolation between the first antenna ANT1 and the second antenna ANT2, both ends of the first conductive pattern 1310, that is, both ends of the first conductive line 1311 may be connected to the ground. In addition, to improve isolation between the third antenna ANT3 and the fourth antenna ANT4, both ends of the second conductive pattern 1320, that is, both ends of the first conductive line 1321 may be connected to the ground.

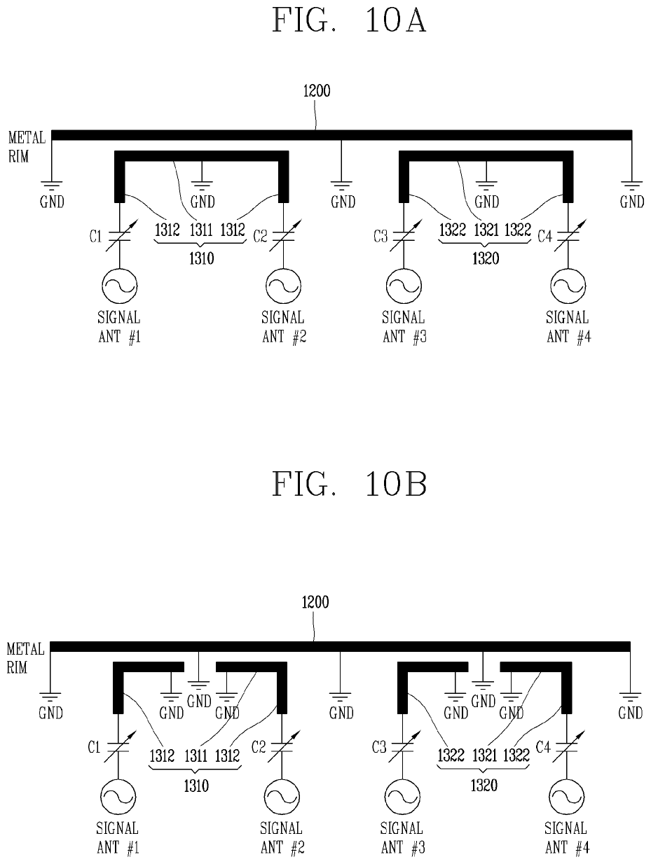

Meanwhile, FIGS. 10A to 10C illustrate various embodiments for improving isolation in the antenna structure according to the present disclosure. In this regard, FIG. 10A illustrates a state in which one point near a center of the conductive pattern is connected to a ground without being cut off. In this regard, one point near the center of the conductive pattern may be connected to the ground of the circuit board.

Referring to FIG. 10A, as signals of the first conductive pattern 1310 and the second conductive pattern 1320 are all coupled to the conductive member 1200 without being cut off, isolation characteristics may be improved. As one point of the first conductive line 1311, 1321 is connected to a ground, isolation characteristic between the plurality of antenna ports is improved.

Meanwhile, FIG. 10B illustrates a state in which a cut-off conductive pattern and one point of the conductive member are connected to a ground in the structure of FIG. 6A. That is, FIG. 10B illustrates a state in which a predetermined offset point from both ends rather than both ends of the cut-off first conductive line 1311, 1321 is connected to a ground. Therefore, a predetermined offset point from a cut-off point may be connected to a ground so that isolation characteristics between the plurality of antenna ports is optimal. In addition, by allowing one point X of the conductive member 1200 between the cut-off conductive lines to be connected to a ground, isolation characteristics between a plurality of antenna ports may be improved. In this regard, one point X of the conductive member 1200 may be connected to a ground of the circuit board.

Meanwhile, FIG. 10C illustrates a state in which the cut-off conductive pattern and one point of the conductive member are connected to a ground in the structure of FIG. 6B. Referring to FIG. 10C, for at least one of the cut-off first conductive lines 1311, 1321, a predetermined offset point from both ends rather than both ends of the cut-off first conductive line 1311, 1321 is connected to a ground. In addition, by allowing one point X of the conductive member 1200 between the cut-off conductive lines to be connected to the ground, isolation characteristics between a plurality of antenna ports may be improved. In this regard, one point of the conductive member 1200 may be connected to the ground of the circuit board. Here, the conductive member 1200 may be connected to a ground at one point X between the cut-off first conductive line 1311, and may not be connected to a ground at one point between another cut-off second conductive line 1312.

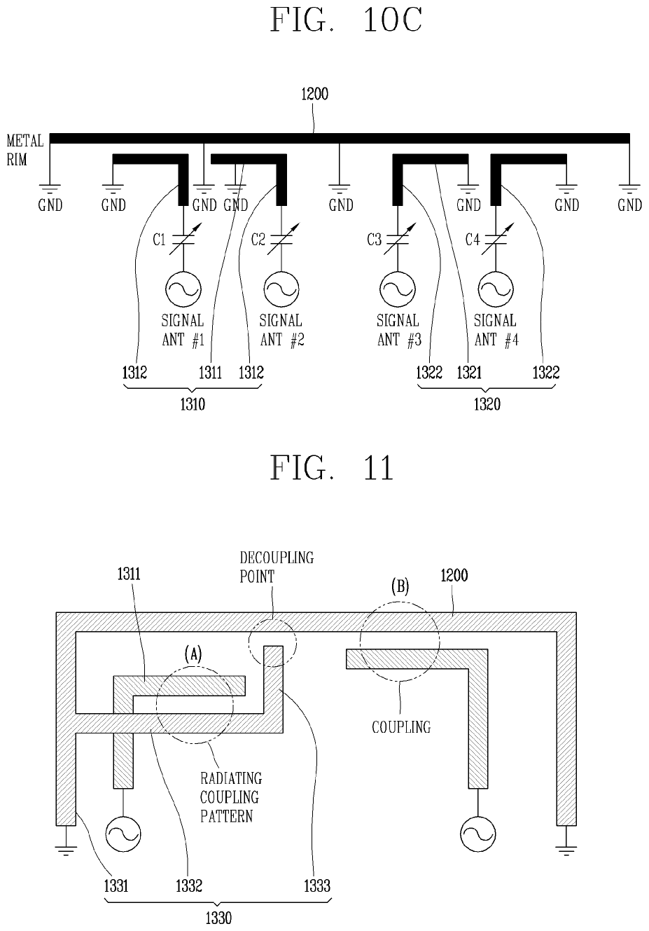

Meanwhile, according to another embodiment of the present disclosure, isolation characteristics may be optimized by allowing conductive patterns of the plurality of antenna elements to be different from each other. In this regard, FIG. 11 illustrates an asymmetric conductive pattern according to another embodiment of the present disclosure. Meanwhile, FIG. 11 is illustrated based on the third antenna ANT3 and the fourth antenna ANT4. However, it is not limited thereto, and the principle may also be applied to the first antenna ANT1 and the second antenna ANT2.

Referring to FIG. 11, a third conductive pattern 1330 connected to a ground of the conductive member 1200 and spaced apart from the conductive member 1200 by a predetermined interval may be further included. Meanwhile, the third conductive pattern 1330 may include third to fifth conductive lines 1331 to 1333. The third conductive line 1331 is configured to connect a ground of the conductive member 1200 and the conductive member 1200. Also, the fourth conductive line 1332 may be connected to one point of the third conductive line 1331 and may be disposed parallel to the conductive member 1200. In addition, the fifth conductive line 1333 may be connected to the fourth conductive line 1332, and an end portion thereof may be disposed to have a predetermined gap from the conductive member 1200.

Meanwhile, as illustrated in FIG. 11, the third antenna ANT3 and the fourth antenna ANT4 are configured to have an asymmetric conductive pattern, and accordingly, isolation characteristics may be improved. To this end, a main region of a radiation pattern of the third antenna may be changed at a predetermined angle by the first cut-off line of the first conductive line 1311, the second conductive line 1312, the third conductive line 1331, and the conductive member 1200.

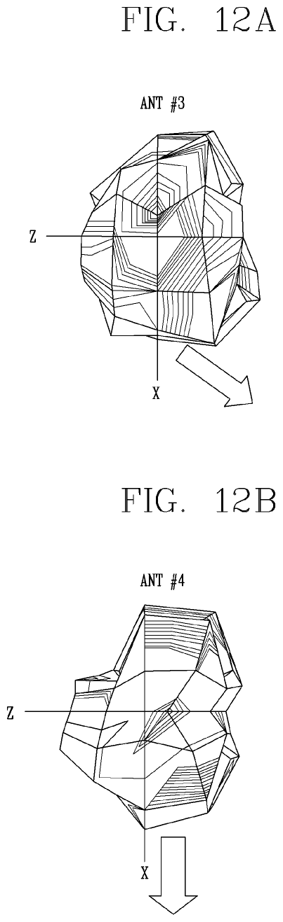

Accordingly, an electric coupling coefficient (ECC) characteristic between a radiation pattern of the third antenna ANT3 and a radiation pattern of the fourth antenna ANT4 may be improved. In this regard, FIGS. 12A and 12B illustrate radiation patterns changed according to asymmetric conductive patterns of a plurality of antennas according to the present disclosure.

Referring to FIG. 11, as indicated by a region A, an electrical coupling may occur between the cut-off first conductive line 1311 and the fourth conductive line 1332 in the third antenna ANT3. In this way, the cut-off first conductive line 1311 and the fourth conductive line 1332 in the region A forms a radiating coupling pattern.

In addition, as indicated by a region B, the conductive member 1200 and the fifth conductive line 1333 are arranged to have a predetermined gap therebetween, so that a decoupling may occur between the third antenna ANT3 and the fourth antenna ANT4. Accordingly, a decoupling point is generated by the predetermined gap between the fifth conductive line 1333 and the conductive member.

Meanwhile, referring to FIG. 12A, the radiation pattern of the third antenna ANT3 is partially changed as the above-described third conductive pattern 1330 is added. Accordingly, a peak value generated point of the radiation pattern of the third antenna ANT3 is different from a peak value generated point of the radiation pattern of the fourth antenna ANT4 of FIG. 12B. Accordingly, ECC characteristics of the radiation pattern of the third antenna ANT3 and the radiation pattern of the fourth antenna ANT4 are improved, and thus, isolation between the plurality of antennas is improved.

Meanwhile, isolation characteristics may be improved by allowing gaps between the cut-off lines and the conductive member to be different in the plurality of antennas. In this regard, a first distance S1 between a first cut-off line 1312a of the first conductive line and the conductive member 1200 and a second distance S2 between a second cut-off line 1312b of the first conductive line and the conductive member 1200 may be different. In this way, isolation between the third antenna and the fourth antenna may be improved by the first distance S1 and the second distance S2 which are different from each other.

Meanwhile, a feeding line feeding a plurality of antennas according to the present disclosure may be disposed on the circuit board 250 of FIG. 2. Specifically, a first feeding part feeding the first conductive pattern 1310 and the second conductive pattern 1320 of the third antenna ANT3 may be disposed on the circuit board 250 of the mobile terminal.

Meanwhile, the third conductive pattern 1330 of the third antenna ANT3 and the first and second conductive patterns 1310 and 1320 of the fourth antenna ANT4 are disposed on the rear case 202 of the mobile terminal. Accordingly, isolation between the third signal applied to the second conductive pattern 1320 of the third antenna ANT3 and the fourth signal applied to the second conductive pattern 1320 of the fourth antenna ANT4 may be improved.

Meanwhile, an antenna structure of a mobile terminal supporting a plurality of communication systems according to another aspect of the present disclosure will be described below. In this regard, referring to FIGS. 2, 3A, 3B, 4A, and 4B, a mobile terminal including antennas supporting a plurality of communication systems has the following characteristics. As described above, a conductive member 1200 forms a part of a side surface metal frame of a mobile terminal. Meanwhile, a plurality of conductive patterns 1300 is configured to be electrically coupled to the conductive member 1200 in the metal frame.

Specifically, the plurality of conductive patterns 1300 includes a first conductive pattern 1310 and a second conductive pattern 1320 disposed on both sides based on a ground of the conductive member.

Meanwhile, an antenna of a first communication system may be implemented by a part of an upper end or a lower end of the metal frame of the mobile terminal. In this regard, referring to FIG. 3A, a plurality of antenna elements 1151 to 1154 supporting the 4G communication service may be disposed on one side surface of the mobile terminal, for example, an upper end portion and a lower end portion.

Meanwhile, multi-input multi-output (MIMO) may be performed in a same frequency band of a second communication system, e.g., the 5G communication system, by a plurality of signals applied to the first conductive pattern 1310 and the second conductive pattern 1320.

Meanwhile, referring to FIGS. 4A and 4B, the first conductive pattern 1310 and the second conductive pattern 1320 include first conductive lines 1311, 1312 and second conductive lines 1312, 1322, respectively. That is, the first conductive pattern 1310 includes the first conductive line 1311 and the second conductive line 1312. In addition, the second conductive pattern 1310 includes the first conductive line 1321 and the second conductive line 1322.

In this regard, the first conductive lines 1311, 1321 are disposed parallel to the conductive member 1200, which is the metal frame. Further, the second conductive lines 1312, 1322 are bent at a predetermined angle to be connected to the first conductive lines 1311, 1321, and configured such that signals from the circuit board 250 are applied thereto.

Meanwhile, a first signal may be applied to one end of the second conductive line 1312 of the first conductive pattern 1310, and a second signal may be applied to another end of the second conductive line 1312 of the first conductive pattern 1310. In addition, a third signal may be applied to one end of the second conductive line 1322 of the second conductive pattern 1320, and a fourth signal may be applied to another end of the second conductive line 1322 of the second conductive pattern 1320.

According to the first signal and the second signal described above, the first conductive pattern 1310 and the conductive member 1200 may operate as a first antenna ANT1 and a second antenna ANT2. On the other hand, according to the third signal and the fourth signal, the second conductive pattern 1320 and the conductive member 1200 may operate as a third antenna ANT3 and a fourth antenna ANT4.

Meanwhile, even in an antenna structure in which both the 4G antennas and the 5G antennas are disposed therein, the contents described with reference to FIGS. 5 to 12 may be applied to improve isolation between 5G antennas.

Referring to FIGS. 3A and 11 in which both the 4G antenna and the 5G antenna are disposed therein, a third conductive pattern 1330 connected to a ground of the conductive member 1200 and spaced apart from the conductive member 1200 by a predetermined gap may be further included. Meanwhile, the third conductive pattern 1330 may include third to fifth conductive lines 1331 to 1333. The third conductive line 1331 is configured to connect a ground of the conductive member 1200 and the conductive member 1200. Also, the fourth conductive line 1332 may be connected to one point of the third conductive line 1331 and may be disposed parallel to the conductive member 1200. In addition, the fifth conductive line 1333 may be connected to the fourth conductive line 1332, and an end portion thereof may be disposed to have a predetermined gap from the conductive member 1200.

Meanwhile, as illustrated in FIG. 11, the third antenna ANT3 and the fourth antenna ANT4 are configured to have an asymmetric conductive pattern, and accordingly, isolation characteristics may be improved. To this end, a main region of a radiation pattern of the third antenna may be changed at a predetermined angle by a first cut-off line of the first conductive line 1311, the second conductive line 1312, the third conductive line 1331, and the conductive member 1200.

Accordingly, an electric coupling coefficient (ECC) characteristic between a radiation pattern of the third antenna ANT3 and a radiation pattern of the fourth antenna ANT4 may be improved.

The foregoing description has been given of a mobile terminal with improved isolation characteristics between a plurality of antenna elements operating in a same frequency band according to the present disclosure has been described. In addition, a mobile terminal having improved isolation characteristics between a plurality of antenna elements operating in a same frequency band in a structure in which a plurality of antennas operating in a plurality of communication systems is disposed has been described.

Hereinafter, technical effects of a mobile terminal and an antenna device according to the present disclosure will be described.

According to at least one of the embodiments of the present disclosure, a mobile terminal connected to a metal frame and performing multi-input multi-output in a same frequency band by a plurality of conductive patterns disposed therein can be provided.

In addition, according to at least one of the embodiments of the present disclosure, a mobile terminal with improved isolation characteristics between a plurality of antenna elements can be provided by changing some of the plurality of conductive patterns.

Further scope of applicability of the present disclosure will become apparent from the following detailed description. It should be understood, however, that the detailed description and specific examples, such as the preferred embodiment of the disclosure, are given by way of illustration only, since various changes and modifications within the spirit and scope of the disclosure will be apparent to those skilled in the art.

In relation to the present disclosure, design and operations of an antenna device can be implemented as computer-readable codes in a program-recorded medium. The computer-readable media may include all types of recording devices each storing data readable by a computer system. Examples of such computer-readable medium may include hard disk drive (HDD), solid state disk (SSD), silicon disk drive (SDD), ROM, RAM, CD-ROM, magnetic tape, floppy disk, optical data storage element and the like. Also, the computer-readable media may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims. Therefore, all changes and modifications that fall within the metes and bounds of the claims, or equivalents of such metes and bounds are therefore intended to be embraced by the appended claims.

1. A mobile terminal comprising:
a conductive member which forms one side surface of a metal frame of the mobile terminal and which is exposed on an exterior of the mobile terminal; and
a plurality of conductive patterns electrically coupled to the conductive member in the metal frame,
wherein the plurality of conductive patterns comprises a first conductive pattern and a second conductive pattern which are disposed at both sides with respect to a ground of the conductive member,
wherein the first conductive pattern operates as a radiator of a first antenna and a second antenna, and the second conductive pattern operates as a radiator of a third antenna and a fourth antenna, and
wherein the first antenna to the fourth antenna operate as a multi-input multi-output (MIMO) in a same frequency band by a plurality of signals.

2. The mobile terminal of claim 1, wherein each of the first antenna to the fourth antenna comprises:
a first conductive line parallel to the conductive member; and
a second conductive line bent at a predetermined angle to be connected with the first conductive line, and to which the signals are applied.

3. The mobile terminal of claim 2, further comprising:
a third conductive pattern connected to the ground of the conductive member, and spaced apart from the conductive member by a predetermined interval,
wherein the third conductive pattern comprises:
a third conductive line connecting the ground of the conductive member and the conductive member;
a fourth conductive line connected to one point of the third conductive line and disposed parallel to the conductive member; and
a fifth conductive line connected to the fourth conductive line and an end portion thereof disposed to have a predetermined gap with the conductive member.

4. The mobile terminal of claim 2, wherein,
a first signal is applied to one end of the second conductive line of the first conductive pattern,
a second signal is applied to another end of the second conductive line of the first conductive pattern,
a third signal is applied to one end of the second conductive line of the second conductive pattern,
a fourth signal is applied to another end of the second conductive line of the second conductive pattern,
wherein each of the first antenna and the second antenna is comprised of the first conductive pattern and the conductive member, and
wherein each of the third antenna and the fourth antenna is comprised of the second conductive pattern and the conductive member.

5. The mobile terminal of claim 2, further comprising:
decoupling lines respectively disposed between the second conductive lines of the first conductive pattern and between the second conductive lines of the second conductive pattern,
wherein the decoupling line comprises:
a first decoupling line disposed in parallel with the first conductive line to connect between the second conductive lines; and
a second decoupling line in which one end thereof is vertically connected to the first decoupling line and another end thereof is connected to the ground.

6. The mobile terminal of claim 2, wherein the first conductive line of the first conductive pattern is in a cut-off form to improve isolation between the first antenna and the second antenna, and
wherein the first conductive line of the second conductive pattern is in a cut-off form to improve isolation between the third antenna and the fourth antenna.

7. The mobile terminal of claim 6, wherein both ends of the first conductive line of the first conductive pattern are connected to the ground to improve isolation between the first antenna and the second antenna, and
both ends of the first conductive line of the second conductive pattern are connected to the ground to improve isolation between the third antenna and the fourth antenna.

8. The mobile terminal of claim 3, wherein a main region of a radiation pattern of the third antenna is changed at a predetermined angle by a first cut-off line of the first conductive line, the second conductive line, the third conductive line, and the conductive member to improve an electric coupling coefficient (ECC) between the radiation pattern of the third antenna and a radiation pattern of the fourth antenna.

9. The mobile terminal of claim 8, wherein a radiating coupling region of the third antenna is formed by the first cut-off line and the third conductive line,
wherein a radiating coupling region of the fourth antenna is formed by a second cut-off line of the first conductive line and the conductive member, and
wherein a decoupling point is formed between the third antenna and the fourth antenna by the end portion disposed to have the predetermined gap with the conductive member.

10. The mobile terminal of claim 3, wherein a first distance between a first cut-off line of the first conductive line and the conductive member and a second distance between a second cut-off line of the first conductive line and the conductive member are allowed to be different from each other to improve isolation between the third antenna and the fourth antenna.

11. The mobile terminal of claim 10, wherein the fifth conductive line is disposed perpendicular to the first cut-off line and the second cut-off line between the first cut-off line and the second cut-off line to improve isolation between the third antenna and the fourth antenna.

12. The mobile terminal of claim 3, wherein a first feeding part configured to feed the first conductive pattern and the second conductive pattern of the third antenna is disposed on a circuit board of the mobile terminal, and the third conductive pattern of the third antenna and the first conductive pattern and the second conductive pattern of the fourth antenna are disposed in a rear case of the mobile terminal to improve isolation between a third signal applied to the second conductive pattern of the third antenna and a fourth signal applied to the second conductive member of the fourth antenna.

13. A mobile terminal, comprising:
a conductive member which forms one side surface of a metal frame of the mobile terminal and which is exposed on an exterior of the mobile terminal; and
a plurality of conductive patterns electrically coupled to the conductive member in the metal frame,
wherein the plurality of conductive patterns comprises a first conductive pattern and a second conductive pattern which are disposed at both sides with respect to a ground of the conductive member,
wherein the first conductive pattern operates as a radiator of a first antenna and a second antenna, and the second conductive pattern operates as a radiator of a third antenna and a fourth antenna,
wherein an antenna of a first communication system is implemented by a part of an upper end or a lower end of the metal frame of the mobile terminal, and
wherein the first antenna to the fourth antenna operate as a multi-input multi-output (MIMO) in a same frequency band by a plurality of signals.

14. The mobile terminal of claim 13, wherein each of the first antenna to the fourth antenna comprises:
a first conductive line parallel to the conductive member; and
a second conductive line bent at a predetermined angle to be connected with the first conductive line, and to which the signals are applied,
wherein,
a first signal is applied to one end of the second conductive line of the first conductive pattern,
a second signal is applied to another end of the second conductive line of the first conductive pattern,
a third signal is applied to one end of the second conductive line of the second conductive pattern,
a fourth signal is applied to another end of the second conductive line of the second conductive pattern,
wherein each of the first antenna and the second antenna is comprised of the first conductive pattern and the conductive member, and
wherein each of the third antenna and the fourth antenna is comprised of the second conductive pattern and the conductive member.

15. The mobile terminal of claim 13, further comprising:
a third conductive pattern connected to the ground of the conductive member, and spaced apart from the conductive member by a predetermined interval,
wherein the third conductive pattern comprises:
a third conductive line connecting the ground of the conductive member and the conductive member;
a fourth conductive line connected to one point of the third conductive line and disposed parallel to the conductive member; and
a fifth conductive line connected to the fourth conductive line and an end portion thereof disposed to have a predetermined gap with the conductive member.
